(19) United States
(12) Patent Application Publication
(10) Pub. No.: US 2023/0102443 A1
(43) Pub. Date: Mar. 30, 2023

(54) MONITORING UNCERTAINTY FOR HUMAN-LIKE BEHAVIORAL MODULATION OF TRAJECTORY PLANNING

(71) Applicant: GM Global Technology Operations LLC, Detroit, MI (US)

(72) Inventors: RAJAN BHATTACHARYYA, SHERMAN OAKS, CA (US); TIFFANY J. HWU, SAN DIEGO, CA (US); MICHAEL J. DAILY, THOUSAND OAKS, CA (US); HYUKSEONG KWON, THOUSAND OAKS, CA (US); MIA LEVY, LOS ANGELES, CA (US)

(21) Appl. No.: 17/487,748

(22) Filed: Sep. 28, 2021

(51) Int. Cl. B60W 60/00; B60W 50/00

(52) U.S. Cl. CPC B60W 60/0027; B60W 50/0098; B60W 2554/4044; B60W 2554/4041; B60W 2555/60; B60W 2554/4042; B60W 2554/4043; B60W 2050/0054; B60W 2552/10

(57) ABSTRACT

A method for monitoring uncertainty for human-like behavioral modulation of trajectory planning includes: retrieving map and agent information of a current driving state of an autonomously operated host automobile vehicle; dividing uncertainty conditions affecting a trajectory of the host automobile vehicle into an expected uncertainty and an unexpected uncertainty; calculating the expected uncertainty in a first operation branch by forming attention zones according to identified portions of lanes which may potentially collide with a planned route of the host automobile vehicle; determining the unexpected uncertainty in a second operation branch by calculating an anomaly score for any other vehicles in a surrounding area of the host automobile vehicle positioned in the lanes which may potentially collide with the planned route of the host automobile vehicle; and modulating trajectory operation signals determined for the expected uncertainty if the unexpected uncertainty meets or exceeds a predetermined threshold.

### INTRODUCTION

The present disclosure relates to systems and methods for generating and modulating trajectories of autonomously operated vehicles.

Autonomously operated automobile vehicles process uncertainty in their environment to make decisions and adjust their processing. Existing autonomous vehicle processing does not operate on human-like systems and methods and therefore lack compatibility with human drivers and passengers.

Uncertainty is monitored and processed in many traditional autonomous driving methods, however traditional autonomous driving methods do not characterize uncertainty based on neuromodulatory principles of the brain. Traditional autonomous driving methods therefore lack human-compatible adaptation processes of behavioral and computational adjustment.

Thus, while current autonomous vehicle trajectory calculation systems and methods achieve their intended purpose, there is a need for a new and improved method for monitoring uncertainty for human-like behavioral modulation of trajectory planning.

### SUMMARY

According to several aspects, a method for monitoring uncertainty for human-like behavioral modulation of trajectory planning includes: retrieving map and agent information of a current driving state of an autonomously operated host automobile vehicle; dividing uncertainty conditions affecting a trajectory of the host automobile vehicle into an expected uncertainty and an unexpected uncertainty; calculating the expected uncertainty in a first operation branch by forming attention zones according to identified portions of lanes which may potentially collide with a planned route of the host automobile vehicle; determining the unexpected uncertainty in a second operation branch by calculating an anomaly score for any other vehicles in a surrounding area of the host automobile vehicle positioned in the lanes which may potentially collide with the planned route of the host automobile vehicle; and modulating trajectory operation signals determined for the expected uncertainty if the unexpected uncertainty meets or exceeds a predetermined threshold.

In another aspect of the present disclosure, the method further includes the retrieving map and agent information of the current driving state including expressing lane information as coordinates, headings, and speed limits.

In another aspect of the present disclosure, the method further includes expressing coordinates, headings, and speeds of agents including other vehicles in the surrounding area of the host automobile vehicle during the retrieving map and agent information of the current driving state.

In another aspect of the present disclosure, the method further includes using the attention zones to filter-out agents including any of the vehicles in the surrounding area of the host automobile vehicle outside of the attention zones, such that the filtered-out agents are not used in further processing.

In another aspect of the present disclosure, the method further includes generating potential trajectory branches for the trajectory of the host automobile vehicle.

In another aspect of the present disclosure, the method further includes selecting an optimum or “best” trajectory branch from the potential trajectory branches to be performed by the host automobile vehicle.

In another aspect of the present disclosure, the method further includes comparing speeds and headings of the other vehicles in the surrounding area of the host automobile vehicle against individual expected speeds and headings of current lane locations of the other vehicles.

In another aspect of the present disclosure, the method further includes obtaining a summary score of the unexpected uncertainty by averaging the anomaly scores of the any other vehicles.

In another aspect of the present disclosure, the method further includes generating a first modulation signal applied to temporarily disable attention zone filtering of the any other vehicles during the modulating trajectory operation signals.

In another aspect of the present disclosure, the method further includes performing the second operation branch in parallel with the first operation branch.

According to several aspects, a method for monitoring uncertainty for human-like behavioral modulation of trajectory planning includes: retrieving map and agent information of a current driving state of an autonomously operated host automobile vehicle; dividing uncertainty conditions affecting a trajectory of the host automobile vehicle into an expected uncertainty and an unexpected uncertainty; determining the expected uncertainty by forming attention zones according to identified portions of lanes which may potentially collide with a planned route of the host automobile vehicle; setting a predetermined threshold such that the attention zones are only used for computation savings when a level of the unexpected uncertainty is below the predetermined threshold; and applying the attention zones to reduce an amount of computation needed to make trajectory decisions wherein hypotheses of vehicles in individual ones of the attention zones defining high attention zones are used to determine when to perform a maneuver, and wherein hypotheses of vehicles outside of the attention zones are not calculated.

In another aspect of the present disclosure, the method further includes: expressing lane information as coordinates, headings, and speed limits during the retrieving map and agent information of the current driving state; and expressing coordinates, headings, and speeds of agents including other vehicles in the surrounding area of the host automobile vehicle.

In another aspect of the present disclosure, the method further includes representing predicted headings of the other vehicles in the surrounding area of the host automobile vehicle in available roadway paths by locations and angles shown as arrows using the map and agent information.

In another aspect of the present disclosure, the method further includes examining a number of planned points ahead of the host automobile vehicle in a radius around the host automobile vehicle.

In another aspect of the present disclosure, the method further includes: evaluating the unexpected uncertainty versus a time; and varying a decay constant to adjust the predetermined threshold over the time.

In another aspect of the present disclosure, the method further includes: projecting multiple points defining the planned route of the host automobile vehicle; and calculating an angle (θ) theta between one of the arrows and one of the multiple points.

In another aspect of the present disclosure, the method further includes drawing a box around one of the arrows and including the one of the arrows and data relating to the one of the arrows in one of the attention zones if the angle θ is less than or equal to approximately 20 degrees, indicating a potential intersection of the path of the one of the arrows and the one of the multiple points.

According to several aspects, a system for monitoring uncertainty for human-like behavioral modulation of trajectory planning includes map and agent information defining a current driving state of an autonomously operated host automobile vehicle. Uncertainty conditions affecting a trajectory of the host automobile vehicle are divisible into an expected uncertainty and an unexpected uncertainty. The expected uncertainty defining attention zones is formed according to identified portions of lanes which may potentially collide with a planned route of the host automobile vehicle. The unexpected uncertainty defines an anomaly score calculated for any other vehicles in a surrounding area of the host automobile vehicle positioned in the lanes which may potentially collide with the planned route of the host automobile vehicle. Trajectory operation signals are determined for the expected uncertainty.

In another aspect of the present disclosure, the attention zones define a filter operating to filter-out agents including any of the vehicles in the surrounding area of the host automobile vehicle outside of the attention zones, thereby eliminating the filtered-out agents from further processing.

In another aspect of the present disclosure, a modulation signal is generated, the trajectory operation signals being modulated by the modulation signal if the unexpected uncertainty meets or exceeds a predetermined threshold.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic flow chart of method steps for performing a method for monitoring uncertainty for human-like behavioral modulation of trajectory planning according to an exemplary aspect;

FIG. 2 is a top plan view of an exemplary 4-way intersection depicting attention zones for expected uncertainty conditions of the present disclosure;

FIG. 3 is a top plan view of an exemplary straight roadway depicting attention zones of the present disclosure;

FIG. 4 is a diagrammatic presentation of a planned travel route of a host automobile vehicle with potential intersecting paths of other vehicles;

FIG. 5 is a top plan view modified from FIG. 2 to depict attention zones for unexpected uncertainty conditions of the present disclosure;

FIG. 6 is a top plan view modified from FIG. 3 to depict attention zones for unexpected uncertainty conditions of the present disclosure;

FIG. 7 is a graph presenting an unexpected uncertainty curve overlayed by a predetermined threshold line;

FIG. 8 is a graph presenting an unexpected uncertainty curve overlayed by a predetermined static threshold line generated using a zero value decay constant;

FIG. 9 is a graph presenting an unexpected uncertainty curve overlayed by a varying threshold line;

FIG. 10 is graph presenting an unexpected uncertainty curve overlayed by a threshold line closely following the unexpected uncertainty curve; and

FIG. 11 is a graph presenting an unexpected uncertainty curve overlayed having no threshold line owing to a decay constant equal to one.

### DETAILED DESCRIPTION

The following description is merely exemplary in nature and is not intended to limit the present disclosure, application, or uses.

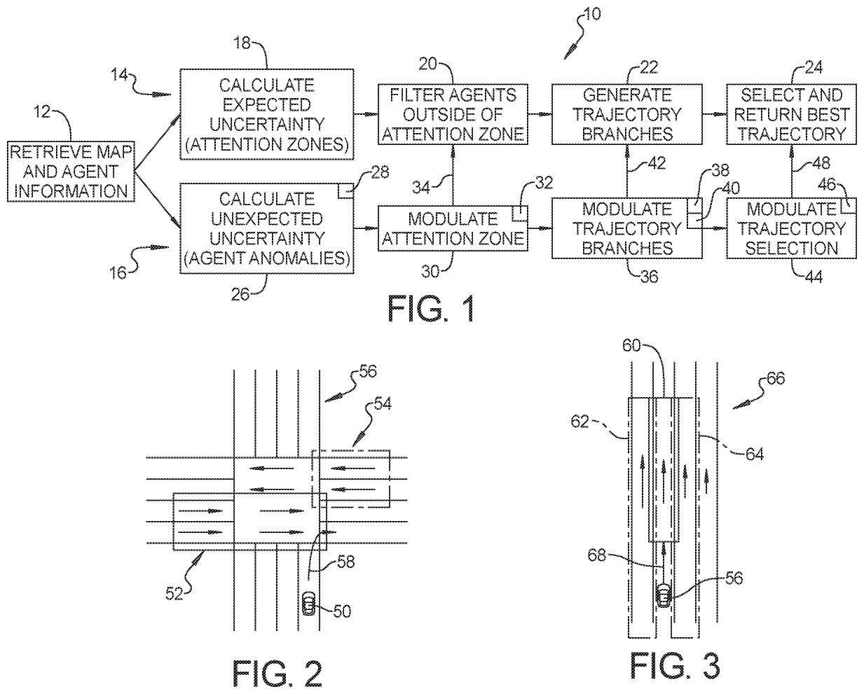

Referring to FIG. 1, a system and method for monitoring uncertainty for human-like behavioral modulation of trajectory planning 10 utilizes uncertainty calculations to affect trajectory outputs for controlling operation of an autonomously operated host automobile vehicle. In an initiation step 12, the system and method for monitoring uncertainty for human-like behavioral modulation of trajectory planning 10 first retrieves map and agent information of a current driving state, including lane information expressed as coordinates, headings, and speed limits, as well as coordinates, headings, and speeds of agents including other vehicles surrounding the host automobile vehicle. Uncertainty conditions affecting a trajectory of the host automobile vehicle are divided into an expected uncertainty and an unexpected uncertainty. A bifurcated operation of stages is then performed in parallel to independently address the expected uncertainty and to identify if the unexpected uncertainty justifies modifying a trajectory of the host automobile vehicle.

The expected uncertainty is addressed in a first operation branch 14, and the unexpected uncertainty is addressed in a parallel second operation branch 16. The unexpected uncertainty determined during the parallel second operation branch 16, if meeting or exceeding predetermined thresholds, may be applied to modulate trajectory operation signals generated for the expected uncertainty determined in the first operation branch 14.

During the first operation branch 14 in a first stage 18 an expected uncertainty is calculated by forming attention zones according to identified portions of the lanes which may potentially collide with the planned route of the host automobile vehicle. In a second stage 20 the attention zones are then used to filter-out agents including other vehicles and objects outside of the attention zones, such that the filtered-out agents are not used in further processing. In a third stage 22 potential trajectory branches are generated. In a following fourth stage 24 an optimum or “best” trajectory branch from the potential trajectory branches is selected to be performed by the host automobile vehicle or to advise an operator of the host automobile vehicle. Methods for branch generation and selection are not limited in the system and method of the present disclosure, with the only requirement being that trajectory generation has the ability to vary speeds and waiting times.

In parallel with the stages performed during the first operation branch 14, during the parallel second operation branch 16 in a fifth stage 26 an unexpected uncertainty is calculated. The unexpected uncertainty may be used to modulate the process of trajectory generation and selection occurring in the first operation branch 14. The unexpected uncertainty is determined by calculating an anomaly score for each other vehicle in a surrounding area of the host automobile vehicle by comparing speeds and headings of the other vehicle or vehicles against individual expected speeds and headings of the current lane locations of the other vehicles. A summary score of unexpected uncertainty 28 is then obtained by averaging the anomaly scores of all the other vehicles. Using the unexpected uncertainty 28, in a sixth stage 30 the calculated unexpected uncertainty 28 is compared to a first threshold 32 and if the unexpected uncertainty 28 exceeds the first threshold 32 a first modulation signal 34 is generated to modify the second stage 20 to temporarily disable attention zone filtering of the other vehicles.

If the calculated unexpected uncertainty 28 does not exceed the first threshold 32, in a seventh stage 36 an analysis of the potential trajectory branches identified originally in the third stage 22 discussed above is performed based on slower trajectories and longer waiting times for the other vehicles which are expected behind stop signs and other temporary roadblocks. A summary of the trajectory branches 38 is inversely proportional to the calculated unexpected uncertainty 28. In the seventh stage 36 the summary of the calculated trajectory branches 38 is compared to a second threshold 40 and if the summary of the calculated trajectory branches 38 exceeds the second threshold 40 a second modulation signal 42 is generated to modify the third stage 22 to modulate the available trajectory branches.

In an eighth stage 44 a determination is made if the optimum or “best” trajectory branch from the potential trajectory branches from the fourth stage 24 requires modulation to alter the selected trajectory taken by the host automobile vehicle. If a third threshold 46 is exceeded, a selection of risk-averse maneuvers such as stopping the host automobile vehicle is selected in a final trajectory selection and a third modulation signal 48 is sent to modify the fourth stage 24 when unexpected uncertainty exceeds the third threshold 46.

Influences of the types of uncertainty on behavior and computation are presented, with each component corresponding to distinct brain functions and circuits. Expected uncertainty is modeled after the neuromodulator acetylcholine and may be defined by attention zones. Unexpected uncertainty is modeled after the neuromodulator norepinephrine and may be defined using anomaly scores such as a heading-based anomaly or a velocity-based anomaly. Trajectories can be described along an axis of two opposing behaviors. One is reward-seeking behavior as defined by preferred speed and reactions to nearby agents and is modeled on the neuromodulator dopamine. The other is risk-aversion, as defined by a willingness to wait for uncertainty to reduce before proceeding with an intended movement, as modeled by the neuromodulator serotonin.

Attention zones can be used by the host automobile vehicle to process other agents differently. For example, the hypothesized trajectories of vehicles within high attention zones may receive more weight, whereas agents completely outside of the zones may be ignored altogether.

Referring to FIGS. 2 and 3 and again to FIG. 1, an autonomous or host automobile vehicle 50 can use attention zones to reduce the amount of computation needed to make trajectory decisions. Hypotheses of vehicles in high attention zones can be used to determine when it is safe to perform a maneuver, whereas hypotheses for vehicles outside of the attention zones do not need to be calculated. This approach decreases the amount of processing and information required to make trajectory decisions. By filtering vehicles outside of attention zones, the savings in computation allows more processing on safety-based features, directing attention toward processes that ultimately maximize the safety of the host automobile vehicle 50. Using knowledge of expected traffic flow, attention zones may be formed by predicting potential collision areas if vehicles are following the flow.

For example, as shown more specifically in FIG. 2, if the host automobile vehicle 50 is stopped at a four-way intersection with traffic lights and intends to make a right turn, important areas of attention will come from traffic flow from the left to right, as well as flow from vehicles on the right that may perform U-turns.

With continuing reference to FIG. 2 attention zones including a high attention zone 52 relating to traffic flow from the left to right and a medium attention zone 54 relating to flow from vehicles on the right that may perform U-turns within a first map 56 coincide with potential collisions when driving the host automobile vehicle 50 along an intended trajectory 58 defining a right-hand turn. Vehicles located outside of the high attention zone 52 and the medium attention zone 54 may receive less computation to reduce computational costs.

Referring more specifically to FIG. 3, the host automobile vehicle 50 driving on a straight freeway would have a high collision potential straight ahead and a medium collision potential with vehicles in neighboring lanes. Attention zones are therefore presented including a high attention zone 60 directly in front of the host automobile vehicle 50, a first medium attention zone 62 to a left-hand side and a second medium attention zone 64 to a right-hand side of the host automobile vehicle 50. These attention zones in a second map 66 coincide with potential collisions when driving the host automobile vehicle 50 along an intended straight trajectory 68. Vehicles located outside of the high attention zone 60 and outside of the first medium attention zone 62 and the second medium attention zone 64 may receive less computation to reduce computational costs.

The presence of an increase in unexpected uncertainty affects expected uncertainty by disabling the use of attention-zones, as the agent should attend to all areas in an anomalous situation.

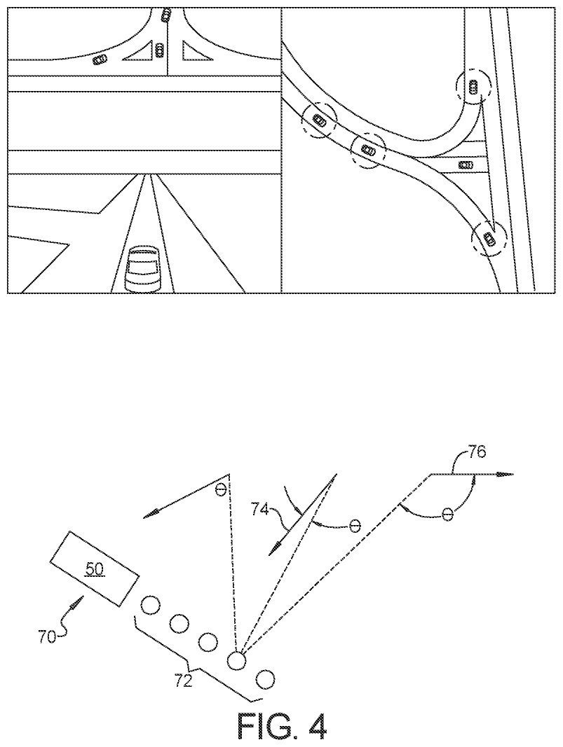

Referring to FIG. 4 and again to FIGS. 1 through 3, the calculation of expected uncertainty produces a collection of attention zones. The host automobile vehicle 50 has a current location 70 and a set of its future planned points 72 is provided as input. All the predicted headings of other vehicles or in available roadway paths in the surrounding area are represented by locations and angles shown as arrows using the map data. The number of planned points 72 ahead of the host automobile vehicle 50 that are examined, defining “num_points”, and a radius around the host automobile vehicle 50 which is examined to look for arrows, “radius”, are configurable parameters. The following pseudocode calculates the attention zones.

For each time step: for every point in num_points ahead of the current host automobile vehicle 50 current location 70, for every arrow (expected headings in surrounding area) within a radius of the host automobile vehicle 50, if an angle (θ) theta between the arrow and the point is sufficiently small, for example angle θ is less than or equal to approximately 20 degrees, indicating a potential intersection of the path of the arrow and at least one of the planned points 72 ahead of the host automobile vehicle 50, a box is drawn around the arrow and the arrow and its data are included in the “attention zone”. If the angle θ between the arrow and the point is large, for example angle θ is greater than approximately 20 degrees, no box is drawn around the arrow and the arrow and its data are not included in the “attention zone”. In the example provided in FIG. 4, a box would be drawn around an arrow 74, however no box will be drawn around an arrow 76.

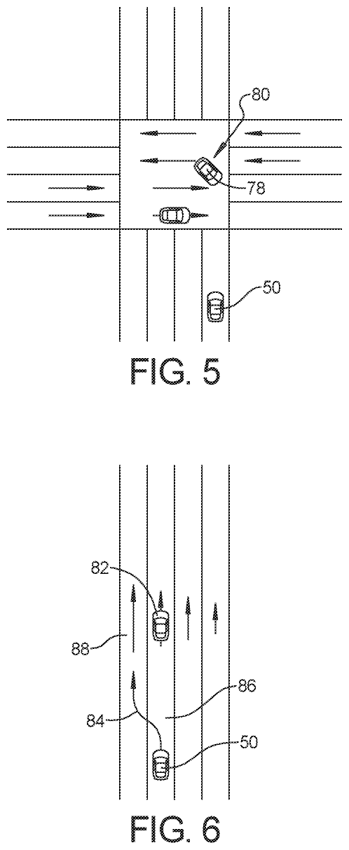

Referring generally to FIGS. 5 and 6 and again to FIGS. 1 through 4, unexpected uncertainty occurs when vehicles do not match their expected behavior. For example, vehicles disobeying traffic rules will deviate from the expected speed or direction of their location. When an unexpected uncertainty increases due to this anomaly, the host automobile vehicle 50 may decide to change its current maneuver according to the situation.

With specific reference to FIG. 5, an increase in unexpected uncertainty, such as an anomalous vehicle 78 not following an expected heading and traveling on a heading that could intercept the current heading of the host automobile vehicle 50 can trigger different behaviors in the decisions of the host automobile vehicle 50. For instance, employing a heading based anomaly the host automobile vehicle 50 may decide to stop if an unusually situated agent such as the anomalous vehicle 78 is present in an intersection 80 which impacts a heading of the host automobile vehicle 50.

With specific reference to FIG. 6, a stalled vehicle 82 is present in a direct path of the host automobile vehicle 50. Employing a velocity-based anomaly the host automobile vehicle 50 encountering the stalled vehicle 82 having a substantially different velocity may decide to change travel lanes using a lane switch maneuver path 84 from a current lane 86 to a prospective lane 88, if available.

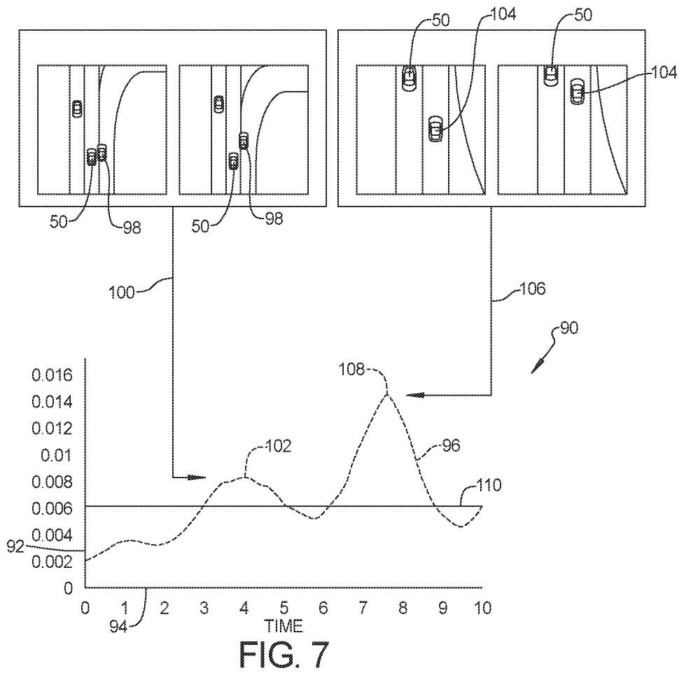

Referring to FIG. 7, to determine when to use attention-zones, a predetermined threshold value can be set such that the attention zones are only used for computation savings when a level of unexpected uncertainty is below a predetermined threshold. The result of employing such a predetermined threshold is that computation can be saved without sacrificing accuracy in crucial situations. With reference to FIG. 7, a graph 90 presents a range of unexpected uncertainty values 92 compared to a time period 94. An unexpected uncertainty curve 96 is generated using unexpected uncertainty values derived for example from a first instance wherein a vehicle 98 initially overtakes and then cuts in front of the host automobile vehicle 50. Unexpected uncertainty data 100 from this maneuver generates a first peak 102 in the unexpected uncertainty curve 96. In a second instance a vehicle 104 changes lanes unexpectedly which potentially impacts a travel path of the host automobile vehicle 50. Unexpected uncertainty data 106 from this maneuver generates a second peak 108 in the unexpected uncertainty curve 96. An exemplary predetermined threshold 110 applied to the data of the graph 90 indicates both the first peak 102 and the second peak 108 exceed the predetermined threshold 110, therefore because the attention zones will be used for computation savings only when the level of unexpected uncertainty is below the predetermined threshold 110, attention zones will not be used for the conditions generating the first peak 102 and the second peak 108.

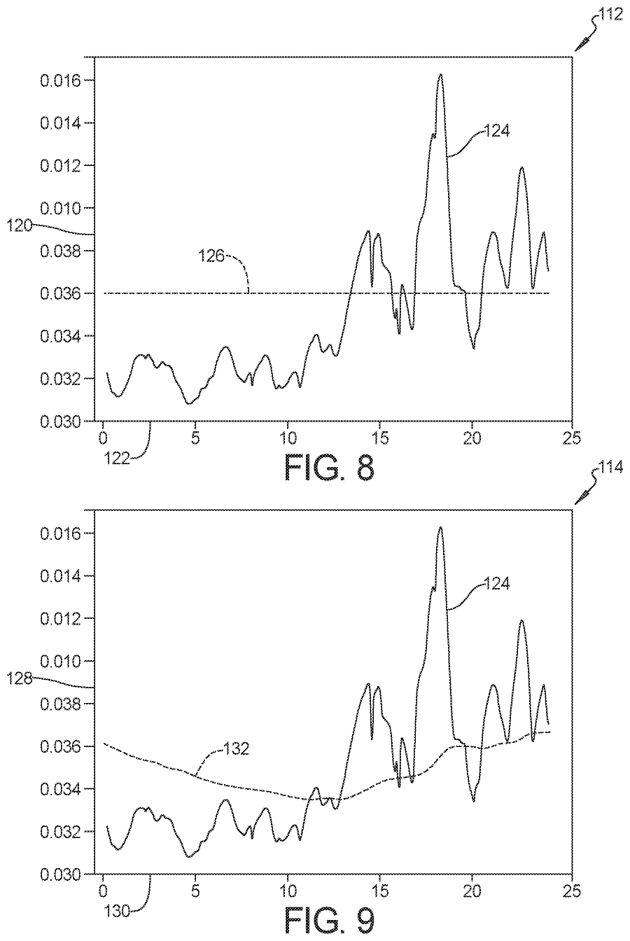

Referring generally to FIGS. 8 through 11 and again to FIG. 7, graphs 112 through 118 individually compare an unexpected uncertainty versus a time, with the effect of varying r on an adjustment of a threshold over time. The selection of a threshold for a computation may require manual tuning specific to the situation. To avoid this, a threshold adjustment may be automated according to a background level of uncertainty using the following equations:

U_{unexpected}=α(h_{ego}−hₗₐₙₑ)+(1−α)(V_{ego}−Vₗₐₙₑ) Equation 1

τ(dθ/dt)=−(θ−U_{unexpected}) Equation 2

Equation symbols are defined as the following:

### U: Uncertainty

### h: Heading

### ν: Velocity

τ: Decay constant
α: Weighting of heading difference compared to velocity difference
θ: Threshold for turning on or off attention-zones

The decay constant, τ, determines how quickly the threshold adjusts to the background level of uncertainty.

Referring more specifically to FIG. 8 the graph 112 compares an unexpected uncertainty 120 versus time 122. For varying values presented in an unexpected uncertainty curve 124, at τ=0, a baseline threshold 126 is static and stays at the initial specified value.

Referring more specifically to FIG. 9 the graph 114 compares an unexpected uncertainty 128 versus time 130. For the same varying values of the unexpected uncertainty curve 124, as τ is increased above 0, a threshold 132 shows variation compared to the baseline threshold 126 of FIG. 8.

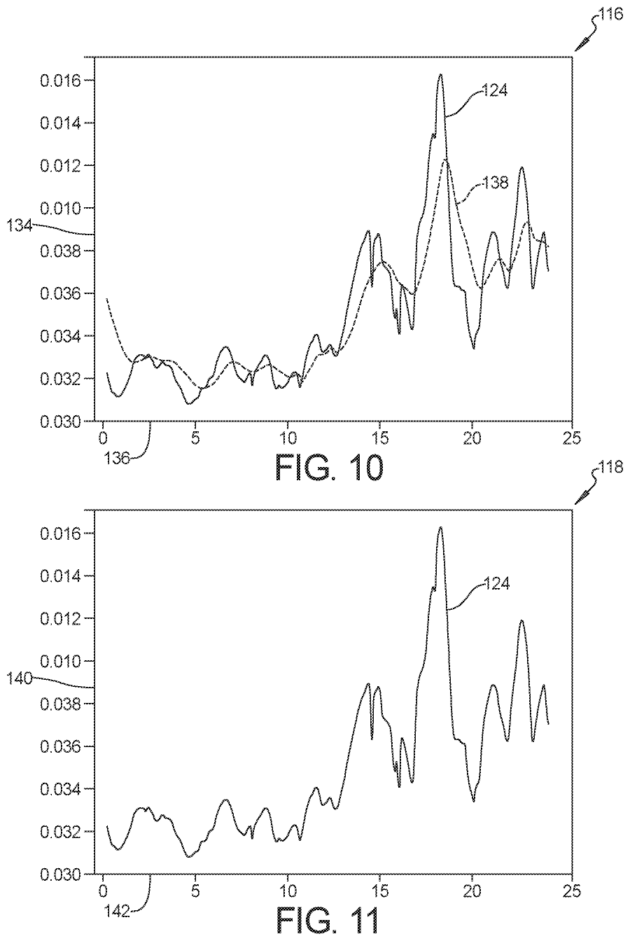

Referring more specifically to FIG. 10 the graph 116 compares an unexpected uncertainty 134 versus time 136. For the same varying values of the unexpected uncertainty curve 124, as r is further increased and approaches 1, a threshold 138 shows variation which more closely tracks the values of the unexpected uncertainty curve 124 compared to the varying threshold 132 of FIG. 9.

Referring more specifically to FIG. 11 the graph 118 compares an unexpected uncertainty 140 versus time 142. For the same varying values of the unexpected uncertainty curve 124, when τ=1, the baseline follows the level of uncertainty instantaneously, such that a threshold is not employed. Thus, based on FIGS. 8 through 11 optimal r values exist between 0 and 1.

The method of trajectory generation for the system and method for monitoring uncertainty for human-like behavioral modulation of trajectory planning 10 of the present disclosure is not restricted to a particular implementation but consists of a collection of plausible trajectories with a defined default speed. When the host automobile vehicle 50 encounters temporary roadblocks such as stop signs, construction zones, and stalled vehicles, the produced trajectories stop the vehicle for a defined wait time. Modulation of trajectory generation changes the parameters of default speed and wait time. The default speed increases inversely with unexpected uncertainty and the wait time increases proportionally with unexpected uncertainty as described by the following equations 3 and 4:

V_{default}=β/U_{Unexpected} Equation 3

t_{wait}=γU_{Unexpected} Equation 4

where V_{default} is the default speed, t_{wait} is the waiting time, and β and γ are constants of value>1.0, manually adjusted to driving conditions and conventional traffic laws.

Just as in the modulation of waiting time, selection of the final trajectory is modulated towards risk averse selections. For example, one method of trajectory generation may consist of a normal trajectory and a failsafe trajectory consisting of an abrupt stop. If the unexpected uncertainty exceeds the predetermined threshold, the failsafe trajectory will be chosen.

A system and method for monitoring uncertainty for human-like behavioral modulation of trajectory planning 10 of the present disclosure offers several advantages. These include autonomous vehicles operated by emulating human cognition for adaptive reduction of computation and intelligent adjustment of driving behaviors. By adjusting the amount of computation according to levels of uncertainty, vehicle safety is maintained by reducing computation only in low-risk, low-uncertainty situations. By behaving in a human-like manner, human drivers in the surrounding area of the autonomous vehicle are more able to predict and anticipate potential movements of the autonomous vehicle for smoother driving in traffic situations involving both human and autonomous drivers, decreasing a risk of collision. The system of the present disclosure is also compatible for semi-autonomous applications, such as driving assistance wherein the system may be used to provide attentional cues to the occupant/operator or to produce trajectories for emergency maneuvers.

A system and method of monitoring uncertainty for modulating the planning of trajectories of an autonomous vehicle is provided for reducing computation of path planning and adjusting driving behaviors. Uncertainty measurements applied in the system and method of the present disclosure are based on neuromodulatory mechanisms of human cognition. This approach leads to a more human-compatible adaptation process of behavioral and computational adjustment.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for monitoring uncertainty for human-like behavioral modulation of trajectory planning, comprising:
retrieving map information and agent information of a current driving state of an autonomously operated host automobile vehicle;
dividing uncertainty conditions affecting a trajectory of the host automobile vehicle into an expected uncertainty and an unexpected uncertainty;
calculating the expected uncertainty in a first operation branch by forming attention zones according to identified portions of lanes which may potentially intercept a planned route of the host automobile vehicle;
determining the unexpected uncertainty in a second operation branch by calculating an anomaly score for any other vehicles in a surrounding area of the host automobile vehicle positioned in the portions of lanes which may potentially intercept the planned route of the host automobile vehicle; and
modulating trajectory operation signals determined for the expected uncertainty if the unexpected uncertainty meets or exceeds a predetermined threshold.

2. The method of claim 1, further including expressing lane information as coordinates, headings, and speed limits.

3. The method of claim 2, further including expressing coordinates, headings, and speeds of agents including other vehicles in the surrounding area of the host automobile vehicle when retrieving map information and agent information of the current driving state.

4. The method of claim 3, further including applying the attention zones to identify agents to be filtered-out including any of the vehicles in the surrounding area of the host automobile vehicle outside of the attention zones, such that the agents to be filtered-out are not used in further processing.

5. The method of claim 1, further including generating potential trajectory branches for the trajectory of the host automobile vehicle.

6. The method of claim 5, further including selecting an optimum or “best” trajectory branch from the potential trajectory branches to be performed by the host automobile vehicle.

7. The method of claim 1, further including comparing speeds and headings of the other vehicles in the surrounding area of the host automobile vehicle against individual expected speeds and headings of current lane locations of the other vehicles.

8. The method of claim 7, further including obtaining a summary score of the unexpected uncertainty by averaging the anomaly score of the any other vehicles.

9. The method of claim 1, further including generating a first modulation signal applied to temporarily disable filtering the attention zones of the any other vehicles during the modulating trajectory operation signals.

10. The method of claim 1, further including performing the second operation branch in parallel with the first operation branch.

11. A method for monitoring uncertainty for human-like behavioral modulation of trajectory planning, comprising:
retrieving map information and agent information of a current driving state of an autonomously operated host automobile vehicle;
dividing uncertainty conditions affecting a trajectory of the host automobile vehicle into an expected uncertainty and an unexpected uncertainty;
determining the expected uncertainty by forming attention zones according to identified portions of lanes which may potentially intercept a planned route of the host automobile vehicle;
setting a predetermined threshold such that the attention zones are only used for computation savings when a level of the unexpected uncertainty is below the predetermined threshold; and
applying the attention zones to reduce an amount of computation needed to make trajectory decisions wherein trajectory data of vehicles in individual ones of the attention zones defining high attention zones are used to determine when to perform a maneuver, and wherein trajectory data of vehicles outside of the attention zones are excluded.

12. The method of claim 11, further including:
expressing lane information as coordinates, headings, and speed limits when retrieving map information and agent information of the current driving state; and
expressing coordinates, headings, and speeds of agents including other vehicles in a surrounding area of the host automobile vehicle.

13. The method of claim 12, further including representing predicted headings of the other vehicles in the surrounding area of the host automobile vehicle in available roadway paths by locations and angles shown as arrows using the map information and the agent information.

14. The method of claim 13, further including examining a number of planned points ahead of the host automobile vehicle in a radius around the host automobile vehicle.

15. The method of claim 14, further including:
projecting multiple points defining the planned route of the host automobile vehicle; and
calculating an angle (θ) theta between one of the arrows and one of the multiple points.

16. The method of claim 15, further including drawing a box around the one of the arrows and data relating to the one of the arrows in one of the attention zones if the angle θ is less than or equal to approximately 20 degrees, indicating a potential intersection of a direction of the one of the arrows with the one of the multiple points.

17. The method of claim 11, further including:
evaluating the unexpected uncertainty versus a time; and
varying a decay constant to adjust the predetermined threshold over the time.

18. A system for monitoring uncertainty for human-like behavioral modulation of trajectory planning, comprising:
map and agent information defining a current driving state of an autonomously operated host automobile vehicle;
uncertainty affecting a trajectory of the host automobile vehicle being divisible into an expected uncertainty and an unexpected uncertainty;
the expected uncertainty divisible into attention zones formed according to identified portions of lanes which may intercept a planned route of the host automobile vehicle;
the unexpected uncertainty defining an anomaly score calculated for any other vehicles in a surrounding area of the host automobile vehicle positioned in the portions of the lanes which may intercept the planned route of the host automobile vehicle; and
trajectory operation signals determined for the expected uncertainty.

19. The system of claim 18, wherein the attention zones define a filter operating to filter-out agents including any of the vehicles in the surrounding area of the host automobile vehicle outside of the attention zones, thereby eliminating the agents from further processing.

20. The system of claim 18, further including a modulation signal, the trajectory operation signals being modulated by the modulation signal if the unexpected uncertainty meets or exceeds a predetermined threshold.
